(19) United States
(12) Patent Application Publication
(10) Pub. No.: US 2007/0239725 A1
(43) Pub. Date: Oct. 11, 2007

(54) Active cache offline access and management of project files

(75) Inventors: Sudin Bhat, Redmond, WA (US); Rajendra Vishnumurty, Bellevue, WA (US); Liang Xiao, Redmond, WA (US); Raju Iyer, Newcastle, WA (US); Pradeep GanapathyRaj, Bellevue, WA (US); Ameya Bhatawdekar, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/390,813

(22) Filed: Mar. 28, 2006

(51) Int. Cl. G06F 17/30

(52) U.S. Cl. 707/10

(57) ABSTRACT

In a client-server computer system, an active cache is utilized by a client-based project management application program to access and manage server-based project files offline. The current status of a connection between the client and the server is monitored. If the status of the connection between the client and server is offline, project files are opened, modified, and saved to the active cache on the client. If the status of the connection between the client and server is online, project files stored in the active cache may be updated by the server prior to being opened. Changes made to project files saved to the cache are synchronized with the server.

### BACKGROUND

With the advent of the computer age, business enterprises and other organizations utilize project management software for scheduling tasks and allocating resources over the course of a project (i.e., a set of activities of finite duration). For example, modern project management application programs assist project managers in developing plans, assigning resources (e.g., people, equipment, and materials) to tasks, tracking progress, managing budgets and analyzing workloads. Each resource can be assigned to multiple tasks in multiple plans and each task can be assigned multiple resources. Tasks are scheduled based on the resource availability as defined in resource calendars. In short, project management application programs greatly facilitate the management of projects in an organization.

In order for multiple users to access the contents of a single project, modern project management application programs also include a collaboration component for accessing a shared project over a computer network so that multiple users may modify different sections of a project simultaneously. For example, a user may access a shared project to update areas the user is personally responsible for. The collaboration component is implemented on a server in a client-server computer network. In the network, a server stores project data in a central database. Users may view, retrieve, and modify server project data from a conventional desktop or laptop computer (i.e., a client computer) by connecting to the server over the network.

In order for multiple users to access the contents of a single project, modern project management application programs also include a collaboration component for accessing a shared project over a computer network so that multiple users may modify different sections of a project simultaneously. For example, a user may access a shared project to update areas the user is personally responsible for. The collaboration component is implemented on a server in a client-server computer network. In the network, a server stores project data in a central database. Users may view, retrieve, and modify server project files from a conventional desktop or laptop computer (i.e., a client computer) by connecting to the server over the network. Project files modified on a client computer may also be synchronized back to the server so that the changes made to the project file are up to date.

Problems occur, however, when the connection between the client computer and the server is broken (e.g., due to a network failure). In such instances, modern project management application programs have no mechanism for detecting when the status of a network connection has changed from online to offline. As a result, file transfers interrupted by a connection may result in corrupt data being left on the server and overall performance is reduced. It is with respect to these considerations and others that the various embodiments of the present invention have been made.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the present invention solve the above and other problems by utilizing, in a client-server computer system, an active cache to access and manage server-based project files offline. The project files may be created and modified using both client and server project management application programs. The active cache is a client-based component which is capable of storing project files from the server as well as storing project files which have been modified offline. The active cache is in communication with the server and thus is capable of communicating data between client and server project management application programs.

According to one embodiment of the invention, the current status of a connection between the client and the server is monitored. If the status of the connection between the client and server is offline, project files are opened, modified, and saved to the active cache on the client. If the status of the connection between the client and server is online, project files stored in the active cache may be updated by the server prior to being opened. Changes made to project files saved to the cache are synchronized with the server. Thus, users are able to access and modify the most recent versions of project files even when the server is disconnected from the client.

According to another embodiment of the invention, a project management application program generates a user interface for managing the project files in the active cache. The user interface, presents a list of the project files stored in the active cache. From the user interface, users may access a number of settings for managing the project files in the active cache. For example, users may delete project files from the active cache, adjust the size of the active cache, and review a status of actions performed on project files (e.g., file saves) in the active cache.

These and various other features, as well as advantages, which characterize the present invention, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a computer network diagram illustrating aspects of several computer systems utilized in and provided by various embodiments of the invention;

FIG. 2 is a computer system architecture diagram illustrating aspects of a client computer system utilized in and provided by various embodiments of the invention;

FIG. 3 is a flow diagram illustrating aspects of a process for utilizing an active cache for opening a project file;

FIG. 4 is a flow diagram illustrating aspects of a process for saving modified project files to an active cache with server synchronization;

FIG. 5 is a flow diagram illustrating aspects of a process for determining if a project file stored in an active cache is the most recent version;

FIG. 6 is a computer screen display illustrating a user interface through which a user can access and manage various settings associated with an active cache for storing project files;

FIG. 7 is a computer screen display illustrating a user interface through which a user can choose a project file to open from a list of project files stored in an active cache;

FIG. 8 is a computer screen display illustrating a user interface through which a user can load multiple project files from a server to an active cache;

FIG. 9 is a computer screen display illustrating a user interface through which a user can access size and location settings for an active cache;

FIG. 10 is a computer screen display illustrating a user interface through which a user can manually remove project files from an active cache; and

FIG. 11 is a computer screen display illustrating a user interface through which a user can view the current status of project files stored in an active cache.

FIG. 12 is a computer screen display illustrating a user interface through which a user can view a current connection status between a server computer system and an active cache stored on a client computer system.

### DETAILED DESCRIPTION

As briefly described above, embodiments of the present invention are directed to utilizing, in a client-server computer system, an active cache to access and manage server-based project files offline. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

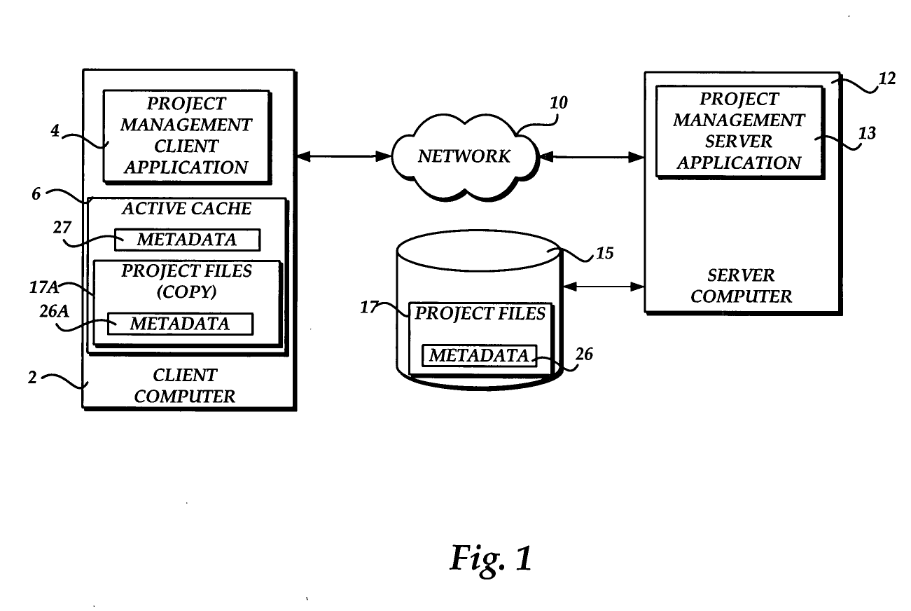

Referring now to the drawings, in which like numerals represent like elements through the several figures, various aspects of the present invention and an illustrative computing operating environment will be described. In particular, FIG. 1 and the corresponding discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process, a computing system, or as an article of manufacture, such as a computer program product or computer-readable media. The computer program product may be a computer storage media readable by a computer system and encoding a computer program of instructions for executing a computer process. The computer program may also be a propagated signal on a carrier readable by a computing system and encoding a computer program of instructions for executing a computer process.

Referring now to FIG. 1, an illustrative operating environment for the several embodiments of the invention will be described. As shown in FIG. 1, a network 10 interconnects a client computer 2 and a server computer 12. It should be appreciated that the network 10 may comprise any type of computing network, including a local area network or a wide area network, such as the Internet. The network 10 provides a medium for enabling communication between the client computer 2, the server computer 12, and potentially other computer systems connected to or accessible through the network 10. The client computer 2 comprises a general purpose desktop or laptop computer capable of executing one or more application programs. In particular, according to the various embodiments of the invention, the client computer 2 is operative to execute a project management client application 4. The project management client application 4 provides functionality for creating projects. Projects may include data for developing plans, assigning resources (e.g., people, equipment, and materials) to tasks, tracking progress, managing budgets and analyzing workloads.

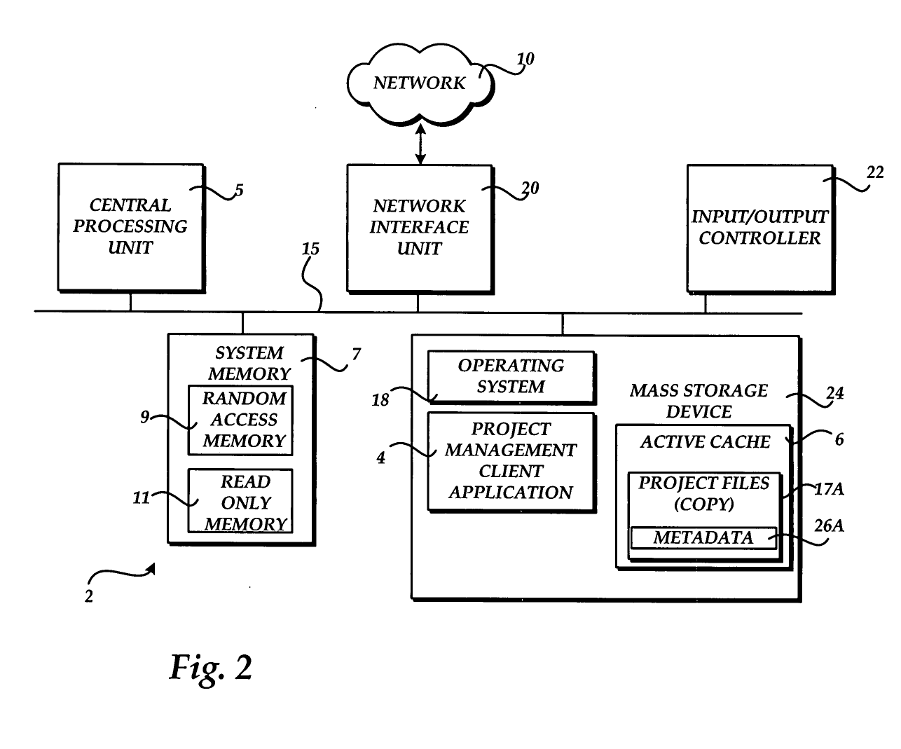

According to embodiments of the invention, the project management client application 4 may be utilized to create or modify project files 17A. The project files 17A are files that may contain one or more tasks relating to project plans, resources, and budgets for a project created in the project management application 4. The client computer 2 also includes an active cache 6. As defined herein, an active cache is a logical storage component which is capable of storing project files. The active cache 6 is in communication with the server 12 and thus is capable of communicating project data between client and server project management applications 4 and 13. The active cache 6 stores the project files 17A. According to the embodiments of the invention, the active cache 6 may be utilized by the project management client application 4 to store copies of project files from the server 12. It should be appreciated that, according to one embodiment of the invention, the project management client application 4 comprises the PROJECT project management application program from MICROSOFT® CORPORATION of Redmond, Wash. It should be appreciated, however, that the various aspects of the invention described herein may be utilized with other project management application programs from other manufacturers. Additional details regarding the functionality of the project management client application 4 and the active cache 6 will be provided below with respect to FIGS. 2-11.

The server computer 12 may be operative to execute a project management server application 13. The project management server application 13 provides functionality for multiple users to collaborate on projects stored in a central database. In particular, the project management server application 13 enables multiple users to access project files 17 stored in database 15. According to various embodiments of the invention, the project management client application 4 may retrieve project files from the server database 15 using a “checkout” procedure. As will be described in greater detail below, project files may be checked out from the server 12 to the client computer 2 by requesting them from the database 15. It should be understood that when a project file is checked out, the original project file remains on the server and a copy of the project file is saved to the client computer. Once a project file is retrieved from the database 15, a flag is set in the database 15 indicating the file as checked out. Once a project file is checked out from the server 12 (through the database 15) to a user, other users are prevented from retrieving or modifying data in the checked out file (i.e., the server-based project file). It should be appreciated that, according to one embodiment of the invention, the project management client application 4 comprises the PROJECT SERVER project management application program from MICROSOFT® CORPORATION of Redmond, Wash. It should be appreciated, however, that the various aspects of the invention described herein may be utilized with other project management application programs from other manufacturers.

According to the various embodiments of the invention, the project management client application 4 and the project management server application 13 are also operative to generate metadata 26A and 26 for identifying various settings and properties associated with a project file. Accordingly, each of the project files 17A and each of the project files 17 includes metadata 26A and 26, respectively. As will be discussed in greater detail below, the metadata 26A and 26 may utilize a number of fields to identify various properties associated with project files. For example, the metadata 26A and 26 may utilize fields to indicate a unique identification for a project file, a date and/or time when a project file was last modified, opened, checked out, attempted to be saved from a client, attempted to be read from a server, updated, and shared out (all of these fields may be assigned a timestamp data type), fields to indicate whether a project file has been checked out from the server (i.e., “IsCheckedOut”—data type “Boolean”), who has checked out a project file (i.e., “Checkout by”—data type “String”), a field indicating whether a checked out project file has been shared for editing by one or more users (i.e., “Project Shared to others”—data type “Boolean”), fields to indicate whether a project was successfully saved to a server, a field to indicate whether a project file is currently opened as a “read-write” file.

According to the various embodiments of the invention, the project management client application 4 is also operative to generate metadata 27 for the active cache 6. The metadata 27 may be used to identify various settings and properties for the active cache 6. For example, the metadata 27 may utilize fields to indicate to indicate the current size of the active cache, the size limit of the active cache, whether the active cache is operating in an online or offline mode (i.e., with respect to the server), when the active cache was last overwritten by the server, and a security hash for ensuring that a user has access to project data when offline from the server.

Referring now to FIG. 2, an illustrative computer architecture for the client computer 2 utilized in the various embodiments of the invention will be described. The computer architecture shown in FIG. 2 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The client computer 2 further includes a mass storage device 24 for storing an operating system 18, application programs, and other program modules, which will be described in greater detail below.

The mass storage device 24 is connected to the CPU 5 through a mass storage controller (not shown) connected to the bus 12. The mass storage device 24 and its associated computer-readable media provide non-volatile storage for the client computer 2. Although the description of computer-readable media contained herein refers to a mass storage device, such as a hard disk or CD-ROM drive, it should be appreciated by those skilled in the art that computer-readable media can be any available media that can be accessed by the client computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the client computer 2.

According to various embodiments of the invention, the client computer 2 may operate in a networked environment using logical connections to remote computers through a network 10, such as the Internet. The client computer 2 may connect to the network 10 through a network interface unit 20 connected to the bus 12. It should be appreciated that the network interface unit 20 may also be utilized to connect to other types of networks and remote computer systems. The client computer 2 may also include an input/output controller 22 for receiving and processing input from a number of other devices, including a keyboard, mouse, or electronic stylus (not shown in FIG. 2). Similarly, an input/output controller 22 may provide output to a display screen, a printer, or other type of output device.

As mentioned briefly above, a number of program modules and data files may be stored in the mass storage device 24 and RAM 9 of the computer 2, including an operating system 18 suitable for controlling the operation of a networked personal computer, such as the WINDOWS® XP operating system from MICROSOFT® CORPORATION of Redmond, Wash. The mass storage device 24 and RAM 9 may also store one or more program modules. In particular, the mass storage device 24 and the RAM 9 may store the project management client application 4, as described above.

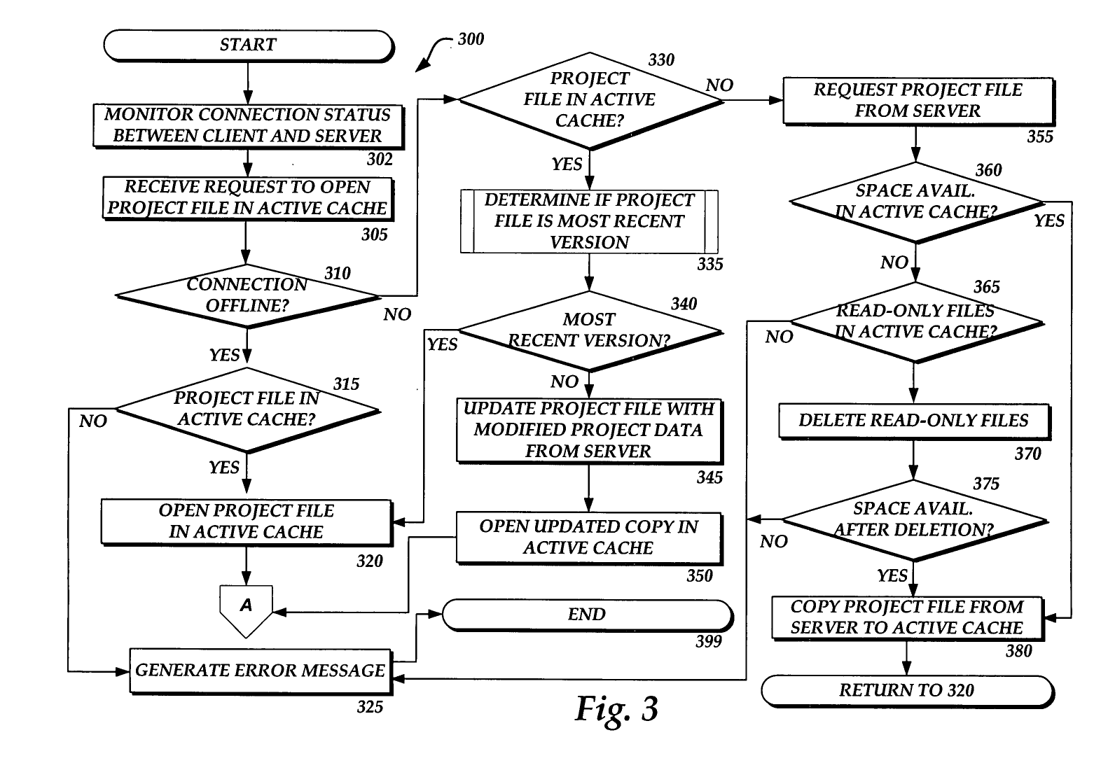

The mass storage device 24 and RAM 9 may also store the active cache 6 for storing the project files 17A and the metadata 26A. According to the embodiments of the invention, the project management client application 4 may utilize the active cache 6 to access and manage server-based project files offline. In particular, the active cache 6 may be utilized to monitor the current status of a connection between the client 2 and the server 12 and open, modify, and save project files if the connection to the server is offline. If the status of the connection between the client and server is online, project files stored in the active cache may be updated by the server prior to being opened. In addition, changes made to project files saved to the cache are synchronized with the server. Illustrative routines describing the access and management of project files will be described in greater detail below with respect to FIGS. 3-5.

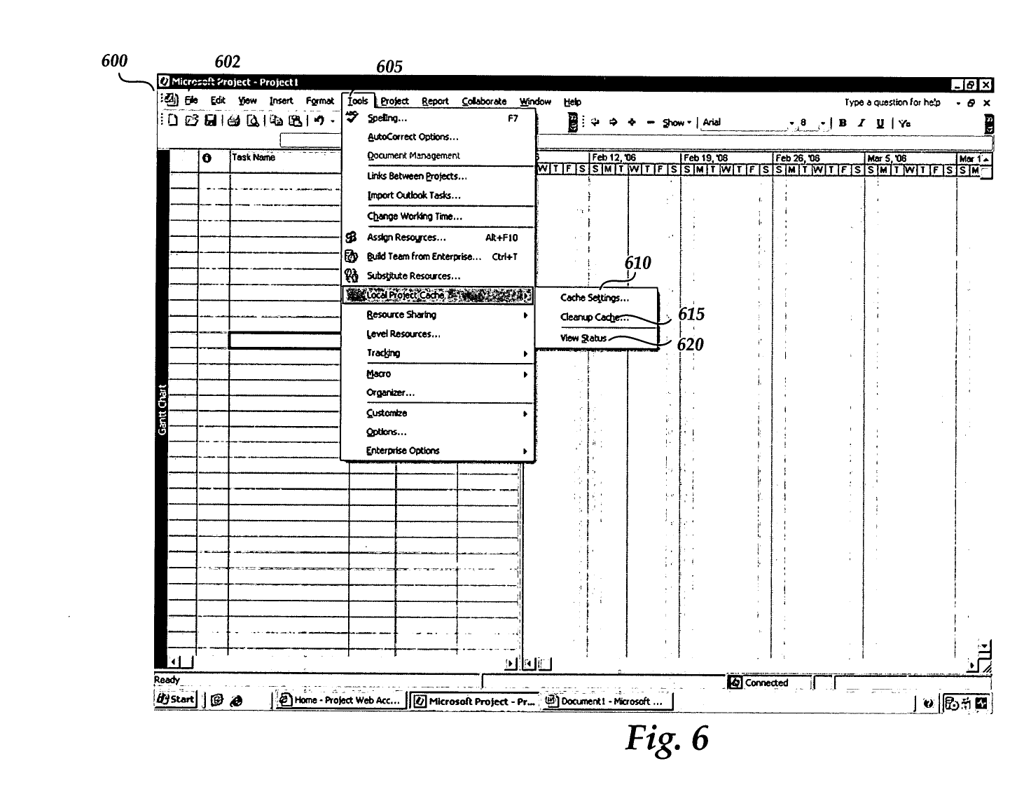

It should be further appreciated that, in embodiments of the invention, the project management client application program 4 is also operative to generate a user interface for managing project files in the active cache 6. For example, the user interface may be used to delete project files, adjust the cache size, and review a status of actions performed on project files (e.g., file saves). Illustrative user interfaces generated by the project management application 4 for managing project files will be described in greater detail below with respect to FIGS. 6-11.

Referring now to FIG. 3, an illustrative routine 300 will be described illustrating a process performed by the performed by the project management client application 4 for utilizing an active cache to open a project file. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 3-5, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 300 begins at operation 302, where the project management client application 4 utilizes the active cache 6 to monitor the connection status between the client computer 2 and the server computer 12. In particular, the project management client application 4 may determine a current connection status from the metadata 27 in the active cache 6. As discussed above, the active cache 6, which is in communication with the server 12, includes metadata 27 which includes fields for identifying various properties including whether the active cache 6 is operating in an online or offline mode. That is, the active cache 6 continually updates the online property in the metadata 27 based on the current connection status of the active cache 6 with the server. As will be described in greater detail herein, the project management client application 4 and the active cache 6 determine how and from where to open project files based on the connection status with the server 12. For example, if the connection status of the server 12 is offline, project files may still be opened from the active cache 6 when requested by a user.

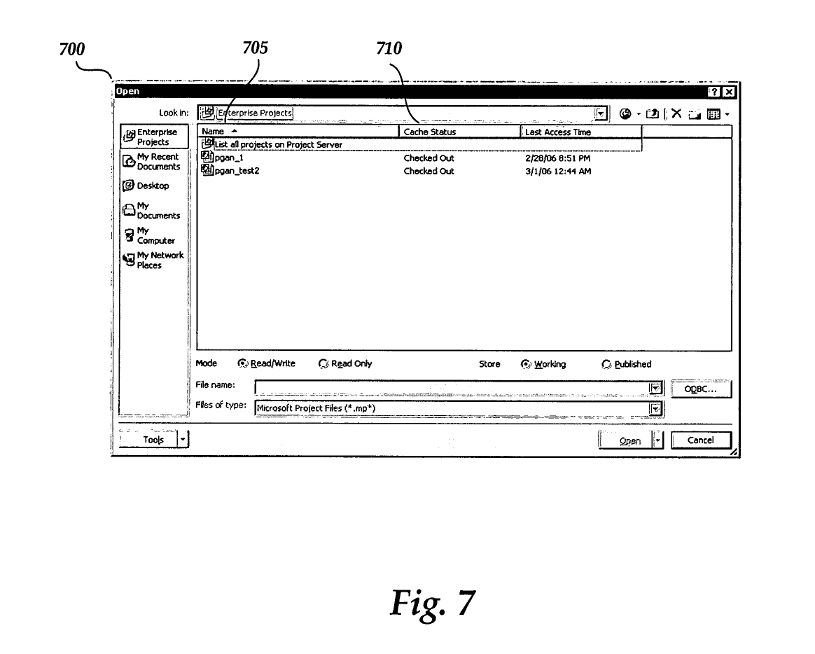

From operation 302, the routine 300 continues to operation 305, where the project management client application 4 receives a request from a user of the client computer 2 to open a project file from the project files 17A stored in the active cache. An illustrative user interface for permitting a user to open a project file will be described in greater detail below with respect to FIG. 7.

From operation 305, the routine 300 continues to operation 310, where the project management client application 4 determines if the network connection between the client computer 2 and the server computer 12 is offline. If, at operation 310, the project management client application 4 determines that the connection is offline, then the routine 300 continues to operation 315, where the project management client application 4 utilizes the active cache 6 to determine if the requested project file stored in the active cache 6.

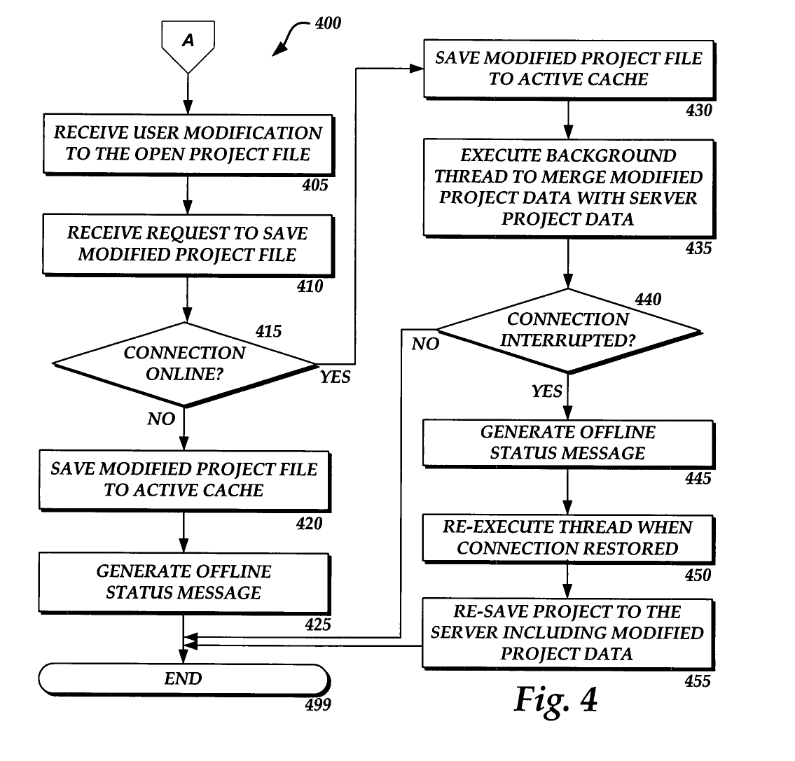

If, at operation 315, it is determined that the requested project file is stored in the active cache 6, then the routine 300 continues from operation 315 to operation 320 where the requested project file is opened from the active cache 6. It should be understood that files opened from the active cache 6 when the connection to the server is offline are opened in the same mode in which they were opened previously (e.g., when the connection to the server was online). For example, if a project file was initially opened as a read-only file from the active cache when the server was online, then the project file is opened as a read-only file when the server is offline. Similarly, if a project file was initially opened as a read-write file when the server was offline, then the project file is opened as a read-write file from the active cache when the server is offline. The routine 300 then continues from operation 320 to off-page connector “A” to operation 405 in routine 400 which will described below with respect to FIG. 4.

If, at operation 315, it is determined that the requested file is not stored in the active cache 6, then the routine 300 branches from operation 315 to operation 325 where the project management client application 4 generates an error message. For example, the error message may be presented as a graphical status bar indicating that the server 12 is offline and the requested project file is not stored in the active cache 6. From operation 325, the routine 300 continues to operation 399, where it ends.

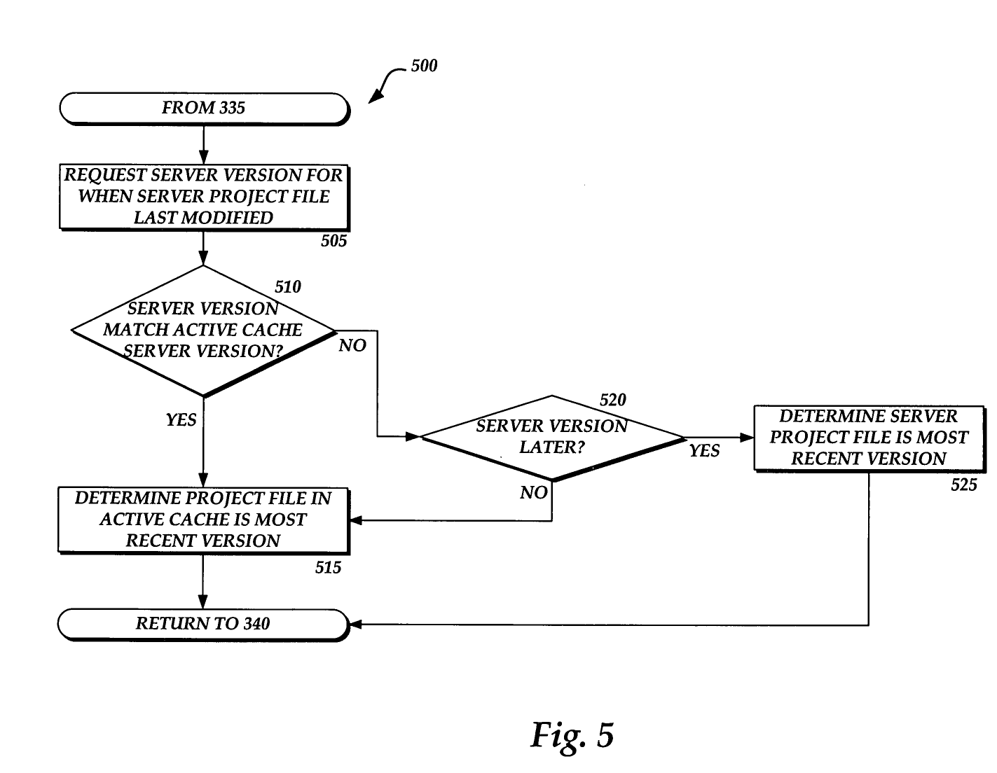

Returning to operation 310, if, at operation 310, the project management client application 4 determines that the connection is online, then the routine 300 branches to operation 330, where the project management client application 4 utilizes the active cache 6 to determine if the requested project file is stored in the active cache 6. If, at operation 310, it is determined that the requested project file is stored in the active cache 6, then the routine 300 continues from operation 330 to operation 335 where the project management client application 4 determines if the project file stored in the active cache 6 is the most recent version of a corresponding project file stored among the project files 17 in the database 15. That is, the project management client application 4 is operative to communicate with the server 12 to determine the most recently saved project file. Additional details regarding the functionality of the project management client application 4 in determining the most recently saved project file will be provided below with respect to FIG. 5.

From operation 335, the routine 300 continues to operation 340 where, if the project file stored in the active cache is the most recent version of the requested project file, then the routine 300 then returns to operation 320 where the requested project file opened from the active cache 6. The routine 300 then continues from operation 320 to off-page connector “A” to operation 405 in routine 400 which will described below with respect to FIG. 4.

If, at operation 340, the project file in the active cache 6 is not the most recent version of the requested project file (as determined in operation 335), then the routine 300 continues to operation 345 where the project management client application 4 utilizes the active cache 6 to update the project file stored in the active cache 6 with modified project data from the server 12. In particular, the project management client application 4 utilizes the active cache 6 to download modified project data from the corresponding project file in the database 15 and merge it with project data contained in the project file stored in the active cache 6 to update the project file stored in the active cache 6. According to one embodiment of the invention, project data from server-based project files may be merged with client-based project files utilizing methods disclosed in U.S. patent application Ser. No. 10/952,284 entitled “Methods and Systems for Caching and Synchronizing Project Data,” which is expressly incorporated herein by reference.

From operation 345, the routine 300 continues to operation 350 where the project management client application 4 opens the updated copy of the project file in the active cache 6. From operation 345, the routine 300 continues to off-page connector “A” to operation 405 in routine 400 which will described below with respect to FIG. 4.

Returning to operation 330, if it is determined that the requested project file is not stored the active cache 6, then the routine 300 branches from operation 330 to operation 355, where the project management client application 4 requests the corresponding project file from the server 12 via the database 15 to save in the active cache 6. From operation 355, the routine 300 continues to operation 360, where the project management client application 4 utilizes the active cache 6 to determine if space is available in the active cache 6 for storing the requested project file from the server 12. In particular, when requesting the corresponding project file from the server 12 to save in the active cache, the project management client application 4 may request the file size (e.g., in megabytes) of the requested project file may be stored in the database 15. The project management client application 4 may then communicate with the active cache 6 and request the space remaining in the active cache 6 for storing project files. In particular, the active cache 6 may retrieve “space remaining” information from the metadata 27. As discussed above, the metadata 27 in the active cache 6 includes a field for indicating the current size of the active cache 6.

If, at operation 360, the project management client application 4 determines that space is available in the active cache 6 for storing the project file requested from the server 12, then the routine 300 branches to operation 380 where the requested project file from the server 12 is copied to the active cache 6. From operation 380, the routine 300 then returns to operation 320 (discussed above).

If, at operation 360, the project management client application 4 determines that space is not available in the active cache 6 for storing the project file requested from the server 12 (i.e., the space remaining in the active cache 6 is smaller than the size of the requested project file), then the routine 360 continues to operation 365 where the project management client application 4 communicates with the active cache 6 to determine if there are only read-only files in the active cache 6. As discussed briefly above, project files may be opened and saved as read-only files and read-write files in the active cache 6. Read-only project files may not be edited or modified in the project management client application 4. On the other hand, read-write files may be modified. It will be appreciated that read-write project files in the active cache 6 may include modified project data which is not in the corresponding version of the project file in the database 15 connected to the server 12.

If, at operation 365, the project management client application 4 determines that there are read-only project files in the active cache 6, the routine 300 then continues to operation 370 where the project management client application 4 instructs the active cache 6 to delete the read-only project files. It should be appreciated that the deletion of the read-only project files from the active cache 6 occurs automatically (i.e., without user intervention). From operation 370, the routine 300 continues to operation 375, where the project management client application 4 communicates with the active cache 6 to determine if there is space available for the requested project file from the server 12 after the deletion of the read-only project files. In particular, the active cache 6 may check the field in the metadata 27 corresponding to space remaining in the active cache to determine if there is enough space to store the requested project file from the server 12.

If, at operation 375, the project management client application 4 determines, after the deletion of the read-only project files, that there is enough space in the active cache 6 to store the requested project file from the server 12, then the routine 300 continues to operation 380 where the requested project file from the server 12 is copied to the active cache 6. From operation 380, the routine 300 returns to operation 320 where the requested project file from the server 12 is opened from the active cache 6.

If, at operation 375, the project management client application 4 determines, after the deletion of the read-only project files, that there still is not enough space in the active cache 6 to store the requested project file from the server 12, then the routine 300 returns to operation 325 where the project management client application 4 generates an error message. For example, the error message may be presented as a graphical status bar indicating that the requested project file from the server 12 may not be copied to the active cache 6 because there is not enough space available (i.e., the active cache 6 is full) and prompt the user to manually delete one or more project files from the active cache 6. It will be appreciated that in one embodiment of the invention, the active cache 6 may automatically delete read-only project files but not read-write project files as these files may have been modified with updated project data which is not contained in the corresponding files stored on the server. From operation 325, the routine 300 continues to operation 399, where it ends.

Returning to operation 365, if the project management client application 4 determines that there are no read-only project files in the active cache 6, the routine 300 returns to operation 325 where the project management client application 4 generates an error message. As discussed above, the error message may be presented as a graphical status bar indicating that the requested project file from the server 12 may not be copied to the active cache 6 because there is not enough space available and prompt the user to manually delete one or more project files from the active cache 6. From operation 325, the routine 300 continues to operation 399, where it ends.

Referring now to FIG. 4, an illustrative routine 400 will be described illustrating a process performed by the project management client application 4 for utilizing the active cache 6 to save modified project files to the active cache 6 and synchronizing the modified project files with the server 12. The routine 400 begins from off-page connector A of FIG. 3 at operation 405, where the active cache 6 receives a modification to an open project file by a user of the program management client application 4. For example, the modification may include adding tasks to an existing project in the project file.

From operation 405, the routine 400 continues to operation 410 where the project management client application 4 receives a request from a user to save the modified project file to the active cache 6. From operation 410, the routine 400 continues to operation 415 where the project management client application 4 communicates with the active cache 6 to determine whether the connection with the server 12 is online as discussed above with respect to FIG. 3.

If, at operation 415, the connection with the server 12 is offline, then the routine 400 continues from operation 415 to operation 420 where the project management client application 4 saves the modified project file to the active cache 6. From operation 420, the operation 400 continues to operation 425 where the project management client application 4 generates an offline status message for the user. For example, the message may be presented as a graphical status bar indicating that the server 12 is currently offline and the modified project file was only saved to the active cache 6. From operation 425, the routine 400 continues to operation 499, where it ends.

If, at operation 415, the connection with the server 12 is online, then the routine 400 continues from operation 425 to operation 430 where the project management client application 4 saves the modified project file to the active cache 6. From operation 430, the routine 400 continues to operation 435 where the active cache 6 automatically executes a background thread to merge (i.e., synchronize) the modified project data with existing project data in the corresponding on the server 12.

From operation 435, the routine 400 continues to operation 440 where the program management client application 4 determines whether the connection with the server 12 has been interrupted. In particular, the program management client application 4 determines whether the connection to the server 12 is interrupted during the execution of the background thread to synchronize the modified project data to the server 12 by communicating with the active cache 6 for a current connection status as discussed above with respect to FIG. 3.

If, at operation 440, the program management client application 4 determines that the connection with the server 12 has been interrupted during the synchronization of the modified project data, then the routine 400 continues from operation 440 to operation 445 where the program management client application 4 generates an offline status message for the user. For example, the message may be presented as a graphical status bar indicating that the connection with the server 12 was interrupted during server synchronization, the current status of the server 12 is offline, and that the modified project data in the active cache 6 was not saved to the server 12.

From operation 445, the routine 400 continues to operation 450, where the active cache 6 re-executes the background thread to synchronize the modified project data with existing project data in the corresponding on the server 12 in response to determining that the connection with the server 12 has been restored. From operation 450, the routine 400 continues to operation 455 where the active cache 6 re-saves the modified project file to the server.

From operation 455, the routine 400 continues to operation 499, where it ends. Returning to operation 440, if the program management client application 4 determines that the connection with the server 12 has not been interrupted during the synchronization of the modified project data, then the routine 400 branches from operation 440 to operation 499, where it ends.

Referring now to FIG. 5, an illustrative routine 500 will be described illustrating a process performed by the project management client application 4 for determining if a project file stored in the active cache 6 is the most recent version of a corresponding project file stored among the project files 17 in the database 15. The routine 500 begins from operation 335 of FIG. 3 at operation 405, where the program management client application 4 identifies, from a server version associated with the corresponding server project file, when the corresponding project file on the server 12 was last modified. In particular, the program management client application 4 may request the server 12 for the server version associated with a project file (i.e., a server-based project file) among the project files 17 stored in the database 15 which corresponds with the project file requested to be opened in the active cache 6. The server version may be retrieved from metadata 26 associated with each of the server-based project files 17 in the database 15. As discussed above with respect to FIG. 1, the metadata 26 may utilize a timestamp data type field to indicate a date and/or time when a project file was last modified.

From operation 505, the routine 500 continues to operation 510 where the project management client application 4 (after receiving the server version for the server-based project file) compares the server version to the corresponding server version for the project file in the active cache 6 (stored in the metadata 26A). If, at operation 510, the project management client application 4 determines that the server versions match, then the routine 500 continues from operation 510 to operation 515 where the program management client application 4 determines that that the project file in the active cache is the most recent version. From operation 515, the routine 500 then returns to operation 340 of the routine 300 described above with respect to FIG. 3.

If, at operation 510, the project management client application 4 determines that the server versions do not match, then the routine 500 continues to operation 520 where the program management client application 4 determines if the server version is later than the server version for the project file in the active cache 6. If at operation 520, the program client application 4 determines that the server version is later, the routine 500 continues from operation 520 to operation 525 where the program management client application 4 determines that the server project file is the most recent version. From operation 525, the routine 500 then returns to operation 340 of the routine 300 described above with respect to FIG. 3. If, at operation 520, the project management client application 4 determines that the server version is not later (i.e., the server version is earlier than the corresponding server version for the project file in the active cache 6) then the routine 500 returns from operation 520 to operation 515 (where it is determined that the project file in the active cache is the most recent version).

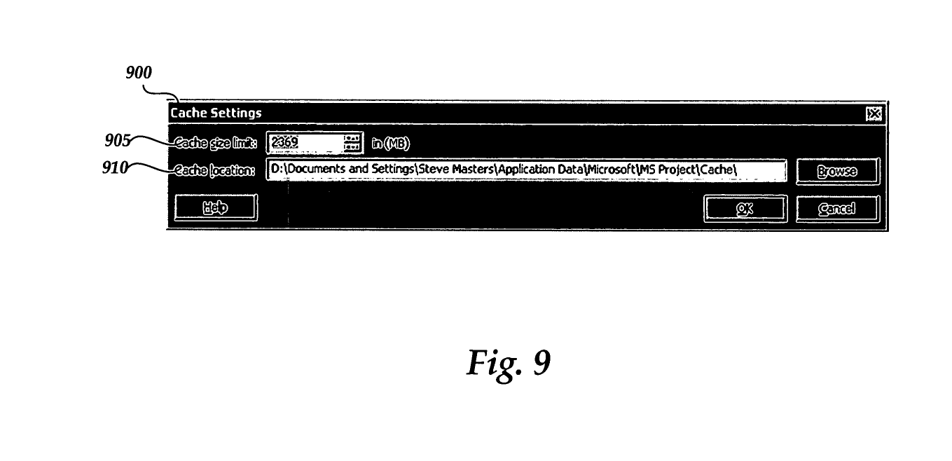

Referring now to FIG. 6, an illustrative user interface will be described for allowing a user to access and manage various settings associated with the active cache 6 for storing project files. FIG. 6 shows a user interface 600 which includes a “File” menu 602 from which a user may open a project file, a “Tools” menu 605 from which a user may access various options for managing the active cache 6 including “Cache Settings” 610, “Cleanup Cache” 615, and “View Status” 620. Each of these options will be described in greater detail below with respect to FIGS. 9-11.

Referring now to FIG. 7, an illustrative user interface will be described for allowing a user to choose a project file to open from a list of project files stored in the active cache 6. FIG. 7 shows a user interface 700 which includes a list of project files. It will be appreciated that the user interface 700 may be accessed from the “File” menu 602 in the user interface 600 of FIG. 6. The user interface 700 includes a “Name” column 705 for identifying the projects stored in the active cache 6 and a “Cache Status” column 710 indicating whether or not a project file has been checked out from the server.

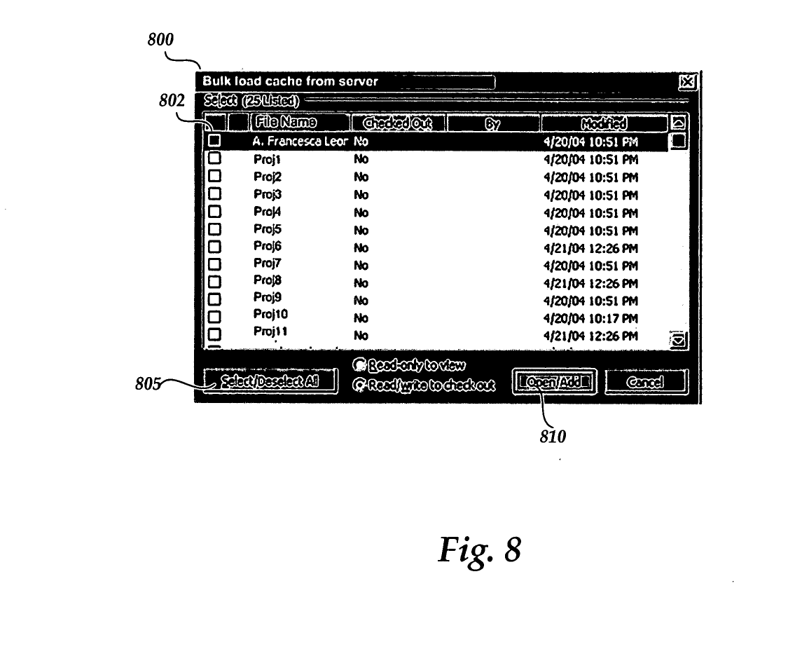

Referring now to FIG. 8, an illustrative user interface will be described for allowing a user to load multiple project files (i.e., bulk load) from the server 12 to the active cache 6. FIG. 8 shows a user interface 800 which includes a list of project files stored in the database 15 associated with the server 12. The user interface 800 includes a checkbox column 802 for selecting individual project files, a “Select/Deselect All” button 805 for selecting or deselecting all of the project files in the displayed list of project files, and an “Open/Add” button 810 for adding additional project files to the list.

Referring now to FIG. 9, an illustrative user interface will be described for allowing a user to access size and location settings for the active cache 6. FIG. 9 shows a user interface 900 which includes a “Cache size limit” window 905 from which a user may view the current size of the active cache 6 and also adjust the size of the active cache 6. For example, a user may choose to increase the size of the active cache 6 upon receiving a status message that the active cache 6 is full during a save operation for a project file. The user interface 900 also includes a “Cache location” window 910 for which a user may view a current directory location for the active cache 6 on the client computer 2 or designate a new directory location for the active cache 6.

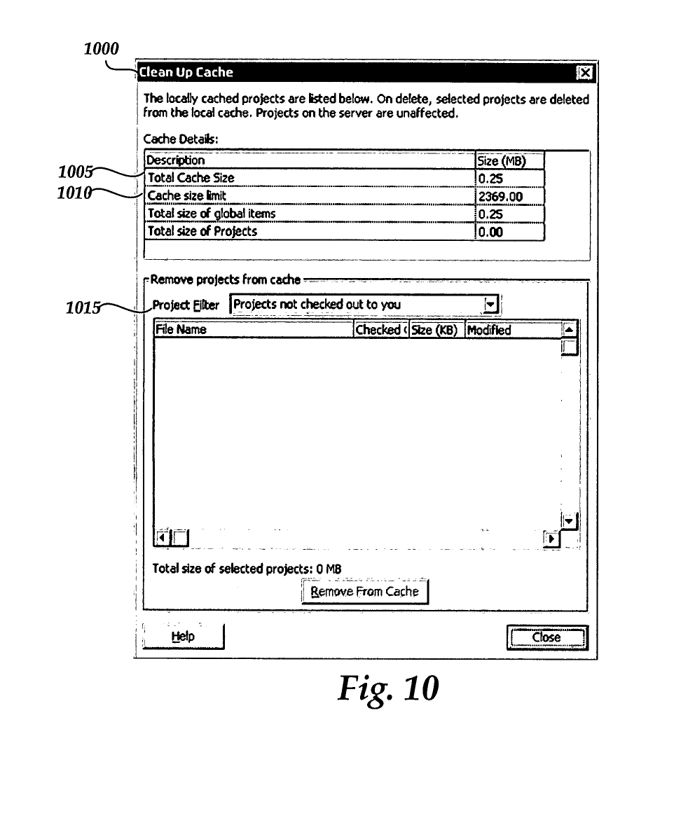

Referring now to FIG. 10, an illustrative user interface will be described for allowing a user to manually remove (i.e., delete) project files from the active cache 6. FIG. 10 shows a user interface 1000 which includes detail information for the active cache 6 such as “Total Cache Size” 1005 and “Cache size limit” 1010. The user interface 1000 also includes a “Project Filter” window 1015 from which a user may select project files for removal from the active cache 6. For example, a user may choose to remove project files from the active cache 6 upon receiving a status message that the active cache 6 is full during a save operation for a project file.

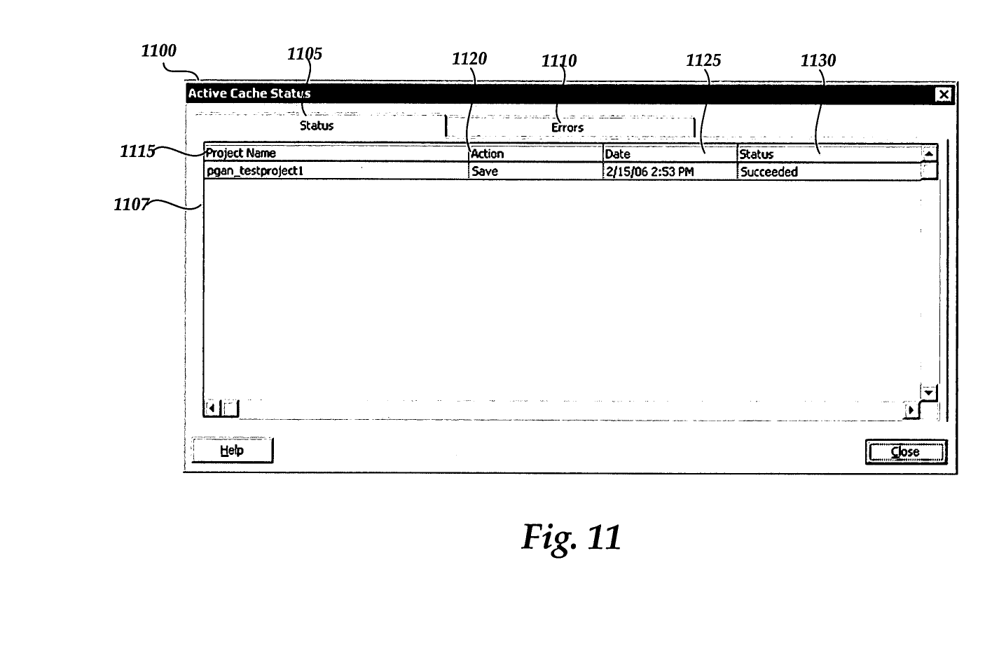

Referring now to FIG. 11, an illustrative user interface will be described for allowing a user to view the current status of project files in the active cache 6. FIG. 11 shows a user interface 1100 which includes a “Status” tab 1105 for displaying information in a window 1107 related to the current status of project files and an “Errors” tab 1110 for displaying information in the window 1107 related to error messages generated with respect to project files. The window 1107 includes a “Project Name” column 1115 for identifying project files, an “Action” column 11120 for identifying an action associated with a project file (e.g., a save operation), a “Date” column 1125 for identifying a date and time when an action occurred, and a “Status” column 1130 indicating whether or not an action succeeded.

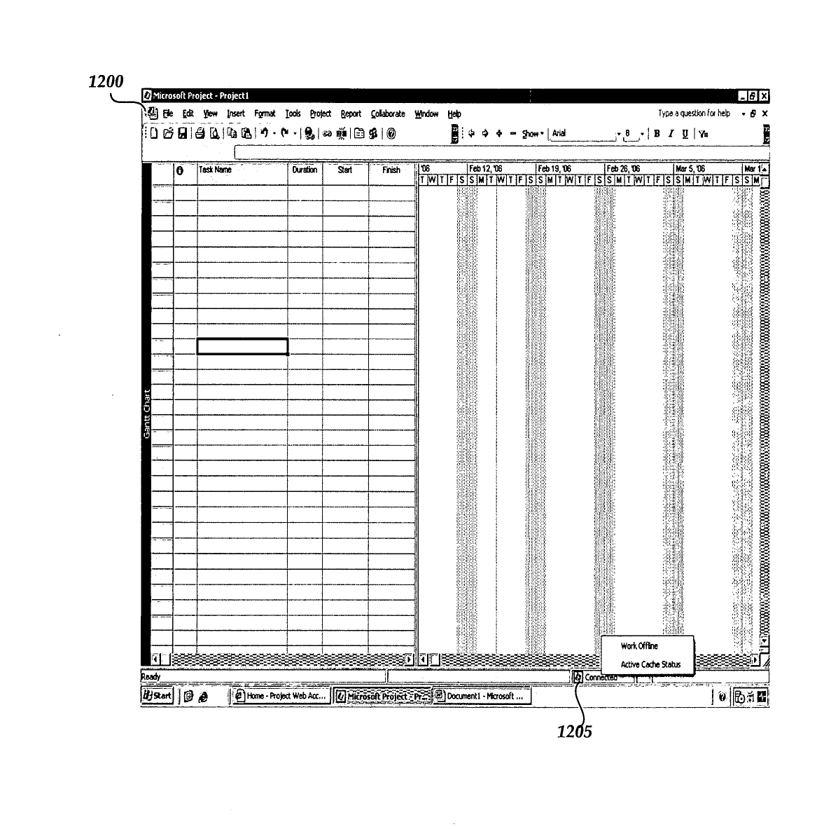

Referring now to FIG. 12, an illustrative user interface will be described for generating a status message indicating the current status of a connection between the server 12 and the active cache 6 (residing on the client computer 2) as offline. FIG. 12 shows a user interface 1200 which includes a status indicator 1205 for displaying the current connection status (e.g., “Connected”).

Based on the foregoing, it should be appreciated that various embodiments of the invention include utilizing, in a client-server computer system, an active cache to access and manage server-based project files offline. It will be apparent by those skilled in the art that various modifications or variations may be made in the present invention without departing from the scope or spirit of the invention. Other embodiments of the present invention will be apparent to those skilled in the art from consideration of the specification and practice of the invention disclosed herein.

We claim:

1. A computer-implemented method for utilizing an active cache for offline access and management of server-based project files in a client-server computer system, comprising:
monitoring the current status of a connection between a client and a server;
receiving a request to open a server-based project file in the active cache;
determining a current status of a connection between the client and the server, wherein the active cache resides on the client;
if the current status is offline, then determining if a copy of the project file is stored in the active cache; and
if a copy of the project file is stored in the active cache, then opening the copy.

2. The method of claim 1 further comprising:
if the current status of the connection between the client and the server is online, then determining if a copy of the project file is stored in the active cache;
if a copy of the project file is stored in the active cache, then determining if the copy of the project file is the most recent version of the project file on the server;
if the copy of the project file is not the most recent version, then requesting the project file from the server;
determining if space is available for storing the requested project file in the active cache;
if space is available for storing the requested project file in the active cache, then updating the copy of the project file in the active cache with project data received from the server; and
opening the updated copy of the project file from the active cache.

3. The method of claim 2 further comprising:
if space is not available for storing the requested project file in the active cache, then determining if at least one read-only file is stored in the active cache;
if at least one read-only file is stored in the active cache, then deleting the at least one read-only file; and
if at least one read-only file is not stored in the active cache, then generating an error message.

4. The method of claim 3 further comprising:
determining if space is available for storing the requested project file in the active cache after deleting the at least one read-only file;
if space is available, then updating the copy of the project file in the active cache with project data received from the server; and
if space is not available, then generating an error message.

5. The method of claim 1 further comprising:
receiving a modification to the open copy of the project file;
receiving a request to save the modified copy of the project file; and
if the current status of the connection between the client and the server is online, then
saving the modified copy of the project file to the active cache; and
executing a background thread to merge project data added in the modified copy of the project file with existing project data in the project file on the server.

6. The method of claim 5 further comprising:
if the connection is interrupted while executing the background thread to merge project data added in the modified copy of the project file with existing project data in the project file on the server, then
generating a status message indicating the current status of the connection as offline; and
re-executing the background thread when the current status of the connection is online.

7. The method of claim 6 further comprising instructing the server to re-save the modified copy of the project file.

8. The method of claim 1 further comprising:
if the copy of the project file is not stored in the active cache, then generating an error message.

9. The method of claim 2 further comprising:
if the copy is the most recent version, then opening the copy of the project file in the active cache.

10. The method of claim 2, wherein determining if the copy is the most recent version of the project file comprises:
communicating with the server to request a server version in metadata for the project file, the server version indicating when the project file was last modified;
comparing the server version for the project file to a corresponding server version for the copy of the project file in the active cache;
if the server versions match, then determining that the copy of the project file is the most recent version of the project file; and
if the server version for the project file is later than the server version for the copy in the active cache, then determining that the project file is the most recent version.

11. The method of claim 2, wherein updating the copy in the active cache with project data received from the server comprises:
requesting project data from the server in the project file which has been modified since the server version for the copy of the project file in the active cache; and
updating the copy of the project file in the active cache with the modified project data.

12. The method of claim 2 further comprising:
if the copy of the project file is not stored in the active cache, then copying the project file from the server into the active cache; and
opening the copy of project file from the active cache.

13. The method of claim 1 further comprising:
if the copy of the project file is the most recent version, then opening the copy of the project file from the active cache.

14. The method of claim 5 further comprising:
if the current status of the connection between the client and the server is offline, then
saving the modified copy of the project file to the active cache; and
generating a status message indicating the current status of the connection as offline.

15. A computer-readable medium having computer-executable instructions stored thereon which, when executed by a computer in a client-server computer system, will cause the computer to perform a method, for managing project files in an active cache, comprising:
generating a user interface for managing the project files in the active cache, wherein the active cache is utilized for offline access to server-based project files and wherein the user interface presents a list of the project files stored in the active cache; and
receiving in the user interface a request to access a plurality of settings for managing the project files in the active cache.

16. The computer-readable medium of claim 15, wherein receiving in the user interface a request to access a plurality of settings for managing the project files in the active cache comprises receiving a request to delete one or more of the project files from the active cache.

17. The computer-readable medium of claim 15, wherein receiving in the user interface a request to access a plurality of settings for managing the project files in the active cache comprises:
receiving a request to save a plurality of files in the active cache from a server, wherein the server is in communication with the active cache; and
saving the requested plurality of files to the active cache as a single group.

18. The computer-readable medium of claim 15, wherein receiving in the user interface a request to access a plurality of settings for managing the project files in the active cache comprises receiving a request to adjust a size limit of the active cache.

19. The computer-readable medium of claim 15, wherein receiving in the user interface a request to access a plurality of settings for managing the project files in the active cache comprises receiving a request to designate a location for the active cache on a client in the client-server computer system.

20. The computer-readable medium of claim 15, wherein receiving in the user interface a request to access a plurality of settings for managing the project files in the active cache comprises receiving a request to for a status of actions associated with the project files stored in the active cache.
